(19) United States
(12) Patent Application Publication
(10) Pub. No.: US 2018/0303109 A1
(43) Pub. Date: Oct. 25, 2018

(54) DAIRY-PRODUCT DETERIORATION-ODOR MASKING AGENT AND DAIRY-PRODUCT DETERIORATION-ODOR MASKING METHOD

(71) Applicant: SAN-EI GEN F.F.I., INC., Osaka (JP)

(72) Inventors: Norikazu FUJIMOTO, Osaka (JP); Taketoshi WATANABE, Osaka (JP); Hisakatsu IWABUCHI, Osaka (JP)

(21) Appl. No.: 15/771,862

(22) PCT Filed: Oct. 28, 2016
(86) PCT No.: PCT/JP2016/082037

§ 371 Date: Apr. 27, 2018

(30) Foreign Application Priority Data
Oct. 30, 2015 (JP) 2015-215264

(51) Int. Cl. A23C 9/152; A23G 9/32; A23L 2/38; A23L 27/00

(52) U.S. Cl. CPC A23C 9/152; A23G 9/32; A23V 2002/00; A23L 27/84; A23L 2/38

(57) ABSTRACT

An object of the present invention is to provide a deterioration-odor masking agent and a deterioration-odor masking method capable of effectively masking deterioration odor of dairy products.

The object is attained by a masking agent comprising one or more members selected from the group consisting of menthyl acetate, linalyl acetate, isoamyl isovalerate, isoamyl butyrate, nerol, acetaldehyde, methyl salicylate, 1,8-cineole, maltol isobutyrate, ethyl pyruvate, heliotropine, diethyl malonate, γ-butyrolactone, ethyl levulinate, benzyl alcohol, hexanal, γ-hexalactone, ethyl propionate, and amyl acetate.

### TECHNICAL FIELD

The present invention relates to a dairy product deterioration-odor masking agent, a dairy product deterioration-odor masking method using the masking agent, and a dairy product comprising the masking agent.

### BACKGROUND ART

Dairy products, typified by cow's milk, fermented milk, and the like, contain proteins, oils and fats, vitamins, minerals, and the like; and have been widely consumed because of this good nutritional balance and desirable palatability.

These dairy products have problematic generation of deterioration odor. For example, when a dairy product packaged in a light-permeable container is displayed in a showcase of a retailer or the like, and exposed to strong light for a long period of time, the riboflavin contained in the milk is excited by light irradiation, and oxidation of a sulfur-containing compound such as methionine or cysteine is sequentially promoted, thus generating off-flavor due to light deterioration (i.e., light-deterioration odor). As a result, the flavor of the dairy product significantly deteriorates.

In view of this problem, a technique of adding at least two or more members selected from L-ascorbic acid, cholecalciferol, and flavonol (Patent Document 1) to a milk-containing acidic beverage; a technique of adding one, or two or more members from rutin, morin, or quercetin (Patent Document 2) to a milk-containing acidic beverage; a technique of incorporating at least one member selected from the group consisting of epicatechin, epigallocatechin, epigallocatechin gallate, chlorogenic acid, caffeic acid, ferulic acid, sinapinic acid, rosmarinic acid, and gallic acid in milk or dairy products (Patent Document 3); and like methods, have been suggested as techniques for inhibiting the generation of deterioration-odor components.

Further, as a technique of masking the said deterioration odor, a technique of incorporating one or more compounds selected from the group consisting of 1,3-octanediol, 5-octene-1,3-diol, and dimethyl methoxyfuranone (Patent Document 4) in a dairy product, and the like, has been suggested.

However, in the techniques disclosed in Patent Documents 1 to 3, although the effects of inhibiting the generation of deterioration-odor components of milk-containing products were confirmed, the inhibitory effects were imperfect. Thus, depending on the history and conditions of light irradiation, the generation of deterioration odor was unavoidable in some cases, and improvement in the technique has therefore been demanded.

In addition, generally, the substance primarily causing the deterioration odor is not limited to the sulfur-containing compounds mentioned above, and also includes mixtures containing other compounds; therefore, the masking effects in the technique of masking the deterioration odor of dairy products disclosed in Patent Document 4 were insufficient, and more versatile and effective masking techniques have been demanded.

### PATENT DOCUMENTS

Patent Document 1: JPH03-272643A
Patent Document 2: Japanese Examined Patent Publication No. H04-21450
Patent Document 3: JP2002-291406A
Patent Document 4: JP2010-200635A

### SUMMARY OF INVENTION

### Technical Problem

An object of the present invention is to provide a novel deterioration-odor masking agent and masking method capable of masking deterioration odor (e.g., light-deterioration odor, which is a light-generated deterioration odor of a dairy product) in a simple, highly safe manner at each stage of production, distribution, storage, sales, and the like, of the dairy product without affecting the flavor and/or taste of the final product.

More specifically, an object of the present invention is to efficiently provide a deterioration-odor masking agent and a masking method ensuring a superior effect, by identifying the major odorants causing deterioration odor of dairy products made of a mixture of various compounds, and using a compound having a masking effect against the odorants.

### Solution to Problem

The inventors of the present invention identified major odorants causing the deterioration odor (specifically, light-deterioration odor), and further carried out extensive research on compounds capable of masking the deterioration odor of dairy products; as a result, the inventors found that a compound or compounds selected from the group consisting of Group A (menthyl acetate, linalyl acetate, isoamyl isovalerate, and isoamyl butyrate), Group B (nerol, acetaldehyde, methyl salicylate, and 1,8-cineole), Group C (maltol isobutyrate, ethyl pyruvate, heliotropine, and diethyl malonate), Group D (ethyl pyruvate, γ-butyrolactone, ethyl levulinate, and benzyl alcohol), and Group E (hexanal, γ-hexalactone, ethyl propionate, and amyl acetate) have superior masking effects against the major odorant compounds causing deterioration odor. With this finding, the inventors completed the present invention.

More specifically, the present invention relates to dairy product deterioration-odor masking agents, deterioration-odor masking methods, and dairy products containing a deterioration-odor masking agent having the following aspects.

Item 1: A dairy product deterioration-odor masking agent, comprising one compound, or two or more compounds selected from the group consisting of the following Groups A to E,
Group A: menthyl acetate, linalyl acetate, isoamyl isovalerate, and isoamyl butyrate;
Group B: nerol, acetaldehyde, methyl salicylate, and 1,8-cineole;
Group C: maltol isobutyrate, ethyl pyruvate, heliotropine, and diethyl malonate;
Group D: ethyl pyruvate, γ-butyrolactone, ethyl levulinate, and benzyl alcohol; and
Group E: hexanal, γ-hexalactone, ethyl propionate, and amyl acetate.
Item 2: The dairy product deterioration-odor masking agent according to Item 1, wherein the dairy product deterioration-odor masking agent comprises two or more compounds selected from the group consisting of Groups A to E, and at least two compounds among the selected compounds are from different groups of Groups A to E.
Item 3: The dairy product deterioration-odor masking agent according to Item 1 or 2, wherein the dairy product deterioration-odor masking agent comprises three or more compounds selected from the group consisting of Groups A to E, and at least three compounds of the selected compounds are from different groups of Groups A to E.
Item 4: A method for masking a deterioration odor of a dairy product, comprising adding the deterioration-odor masking agent according to any one of Items 1 to 3 to a dairy product.
Item 5: A method for producing a dairy product, comprising adding the deterioration-odor masking agent according to any one of Items 1 to 3 to a dairy product.
Item 6: A dairy product comprising the deterioration-odor masking agent according to any one of Items 1 to 3.

### Advantageous Effects of Invention

Using the masking agent of the present invention for a dairy product makes it possible to efficiently mask deterioration odor of the dairy product. Therefore, since it is possible to mask the deterioration odor generated by exposure to light or the like at each stage of production, distribution, storage, display, and the like of dairy products, and thereby prevent deterioration of the flavor and/or taste of the dairy products, it is possible to easily and effectively maintain the quality of dairy products.

### DESCRIPTION OF EMBODIMENTS

In the present specification, the term “comprise” or “contain” is used with the intention of including the terms “consist of” and “consist only of.”

Unless otherwise specified, the operations and the steps described in this specification may be performed under room temperature.

In this specification, the term “room temperature” is understood according to common technical knowledge. For example, “room temperature” may mean a temperature in the range of 10° C. to 35° C.

The present invention is more specifically explained below.

The “dairy product” of the present invention refers to milk itself, or to a product produced using milk as a raw material; it is not particularly limited insofar as it falls within these criteria.

Examples of milk include raw milk, cow's milk, partially defatted milk, defatted milk, and processed milk.

Examples of dairy products include fermented milk, concentrated milk, defatted concentrated milk, condensed milk, whole milk powder, non-fat dry milk, sweetened milk powder, creams, cheese, and butter; as well as food and drinks containing one or more of the milk and dairy products listed above, such as beverages (lactobacillus beverages, milk beverages, coffee beverages, soft drinks, and the like), confectioneries (e.g., pudding, jelly, Bavarian cream, Chinese almond jelly, biscuits, and the like), ice cream, breads, and the like.

The dairy product deterioration odor of the present invention is preferably a dairy product light-deterioration odor.

As shown in the Examples described later, in the present invention, the inventors identified major odorants causing deterioration odor (specifically, light-deterioration odor).

Briefly, the present inventors identified the major odorants causing deterioration odor of a dairy product by

(1) analyzing odorant components of a dairy product in which deterioration odor is generated by light irradiation, and a dairy product free of light deterioration, using a gas chromatography olfactometer (hereinafter abbreviated as GC/O); and
(2) specifying the substance primarily causing the deterioration odor from among the odorant components generated by light irradiation (i.e., odorant component(s) increased in a dairy product in which deterioration odor is generated by light irradiation, compared with a dairy product free of light deterioration).

Specific preferable examples of such major odorant substances include dimethyl disulfide, 1-octen-3-one, methional, 4,5-epoxy-trans-2-decenal, and trans-2-nonenal.

The deterioration-odor masking agent for a dairy product of the present invention (the masking agent may be referred to as “a deterioration-odor masking agent” or “a masking agent” in this specification) comprises one or more compounds (the compounds may be referred to as a masking agent compound in this specification) selected from the group consisting of the following Groups A to E as an active ingredient.

Group A: menthyl acetate, linalyl acetate, isoamyl isovalerate, and isoamyl butyrate;
Group B: nerol, acetaldehyde, methyl salicylate, and 1,8-cineole;
Group C: maltol isobutyrate, ethyl pyruvate, heliotropine, and diethyl malonate;
Group D: ethyl pyruvate, γ-butyrolactone, ethyl levulinate, and benzyl alcohol; and
Group E: hexanal, γ-hexalactone, ethyl propionate, and amyl acetate.

The compounds of Groups A to E are all known flavor components.

In the present invention, extracts from natural products, the purified products thereof, and synthetic products obtained by chemical reaction may be used as these compounds without limitation. Simply, commercially available products of these compounds may preferably be used in the present invention.

The compounds in Group A, i.e., menthyl acetate, linalyl acetate, isoamyl isovalerate, and isoamyl butyrate, each effectively function as a dairy product deterioration-odor masking agent. In particular, they effectively function as a masking agent against, among the major odorant substances listed above that cause deterioration odor, dimethyl disulfide.

The compounds in Group B, i.e., nerol, acetaldehyde, methyl salicylate, and 1,8-cineole, each effectively function as a dairy product deterioration-odor masking agent. In particular, they effectively function as a masking agent against, among the major odorant substances listed above that cause deterioration odor, 1-octen-3-one.

The compounds in Group C, i.e., maltol isobutyrate, ethyl pyruvate, heliotropine, and diethyl malonate, each effectively function as a dairy product deterioration-odor masking agent. In particular, they effectively function as a masking agent against, among the major odorant substances listed above that cause deterioration odor, methional.

The compounds in Group D, i.e., ethyl pyruvate, γ-butyrolactone, ethyl levulinate, and benzyl alcohol, each effectively function as a dairy product deterioration-odor masking agent. In particular, they effectively function as a masking agent against, among the major odorant substances listed above that cause deterioration odor, 4,5-epoxy-trans-2-decenal.

The compounds in Group E, i.e., hexanal, γ-hexalactone, ethyl propionate, and amyl acetate, each effectively function as a dairy product deterioration-odor masking agent. In particular, they effectively function as a masking agent against, among the major odorant substances listed above that cause deterioration odor, trans-2-nonenal.

The deterioration-odor masking agent of the present invention is characterized by comprising one compound, or two or more compounds selected from the group consisting of Groups A to E.

The masking effects may be obtained by using only one compound among the compounds listed above; more desirable masking effects may be obtained by using two or more compounds among the compounds listed above; and further desirable masking effects may be obtained by using three or more compounds among the compounds listed above.

In the present invention, in terms of desirable masking effects, it is preferable to use one or more compounds selected from two different groups among Groups A to E (in total, two or more compounds).

It is more preferable to use one or more compounds from three different groups among Groups A to E (in total, three or more compounds).

It is further preferable to use one or more compounds from four different groups among Groups A to E (in total, four or more compounds).

It is particularly preferable to use one or more compounds from five different groups among Groups A to E (in total, five or more compounds).

The amount of the deterioration-odor masking compound of the present invention (for example, the content of the deterioration-odor masking agent of the present invention relative to the dairy product) may be any amount insofar as the deterioration-odor masking effects are ensured.

Specifically, the concentration of each compound relative to the entire dairy product is preferably in a range of 0.0000025 ppb to 100000 ppb; more preferably in a range of 0.000025 ppb to 10000 ppb; and further preferably in a range of 0.00025 ppb to 1000 ppb.

If the amount is excessively small, the masking effects may be insufficient. On the other hand, if the amount is excessively large, the odor and/or taste originating from the masking agent compound may undesirably affect the odor and/or taste of the dairy product.

In the present invention, the total mass (total concentration) of the compounds in each group of Groups A to E is preferably similar to the mass (or concentration) of the odorant substance, which is a preferable masking target (i.e., the object against which the compound effectively serves as a masking agent) (e.g., a ratio between 1:10 to 10:1, a ratio between 1:9 to 9:1, a ratio between 1:8 to 8:1, a ratio between 1:7 to 7:1, a ratio between 1:6 to 6:1, a ratio between 1:5 to 5:1, a ratio between 1:4 to 4:1, a ratio between 1:3 to 3:1, a ratio between 1:2 to 2:1, a ratio between 2:3 to 3:2, or a ratio between 3:4 to 4:3).

Remarkably, the masking effects with respect to the target odorant substance may be weakened not only when the amount of the masking agent compound is small, but also when the amount of the masking agent compound is excessively large.

The deterioration-odor masking agent of the present invention may comprise a compound other than the masking agent compound.

The form of the deterioration-odor masking agent of the present invention, and the kind and the amounts of the other compounds may be appropriately selected according to the usage form and the like of the deterioration-odor masking agent of the present invention.

For example, the deterioration-odor masking agent of the present invention may be in a liquid form consisting only of the masking agent compound; or in the form of a diluted liquid agent in which one or more masking agent compounds are dissolved at an appropriate concentration in a solvent obtained using solely, or as a mixture, water, alcohol, glycerin, and propylene glycol, and the like.

Further, for example, the deterioration-odor masking agent of the present invention may be a powdered preparation prepared by adding an excipient such as dextrin to a solution of one or more masking agent compounds, followed by powderization by means of spray-drying or the like.

The deterioration-odor masking agent of the present invention may be in the form of a flavor preparation. The flavor preparation may be obtained, for example, by adding one or more masking agent compounds to a flavor composition containing a flavor component (flavor component(s) other than the masking agent compound). The flavor preparation may be used for a dairy product by a method and conditions similar to those of previously known flavor preparations.

Examples of other flavor components include the natural flavors, synthetic flavors, and the like disclosed on pages 7 to 87 of the “Patent Office Report, Collection of Well-Known Prior Arts (Perfume), Part II, Food Flavor” (Japan Patent Office, published on Jan. 14, 2000).

In view of convenience in use, the deterioration-odor masking agent of the present invention may preferably be a diluted liquid agent, a powdered preparation, or a flavor preparation; and more preferably a flavor preparation.

The timing and the method in applying the deterioration-odor masking agent of the present invention or a preparation containing the masking agent are not particularly limited; the deterioration-odor masking agent of the present invention or a preparation containing the masking agent may be added or used at any stage of manufacture of a dairy product.

Further, for example, the deterioration-odor masking agent of the present invention or a preparation containing the masking agent may be added to or used in a dairy product by adding or using the deterioration-odor masking agent of the present invention, or a preparation containing the masking agent, to a raw material of a dairy product; and then adding or using the raw material to produce a dairy product.

The deterioration-odor masking agent of the present invention may be used for dairy products containing various food materials that are used for general dairy products.

Examples of such food materials include sugars, sweeteners, thickeners, emulsifiers, vitamins, fruit juices, and flavors.

Specific examples of such food materials include sucrose, glucose, fructose, palatinose, xylose, maltose, and like sugars; sorbitol, xylitol, erythritol, palatinit, reduced starch syrup, and like sugar alcohols; aspartame, thaumatin, sucralose, acesulfame-K, stevia, and like high intensity sweeteners; agar, gelatin, carrageenan, guar gum, xanthan gum, pectin, locust bean gum, gellan gum, and like thickeners; sucrose fatty acid ester, glycerin fatty acid ester, sorbitan fatty acid ester, lecithin, and like emulsifiers; vitamin A, vitamin B, vitamin C, vitamin E, and like vitamins; strawberry juice, blueberry juice, grape juice, white grape juice, and like fruit juice; and strawberry flavor, blueberry flavor, grape flavor, muscat flavor, and like flavors.

(1) The method for producing a dairy product of the present invention, (2) the method for masking dairy product deterioration odor of the present invention, (3) the method for producing a dairy product of the present invention, and (4) the dairy product of the present invention may be understood, for example, from the explanations of the dairy product deterioration-odor masking agent or the like of the present invention.

### EXAMPLES

The present invention is specifically described below with reference to the following Examples. However, the present invention is not limited to these Examples.

In the Examples below, the values showing an amount and concentration may be based on mass, unless otherwise specified.

Hereinbelow, “(R)” represents a registered trademark of San-Ei Gen F.F.I., Inc.

### Test Example A (Identification of Major Odorant Substance)

Major odorant substances causing light-deterioration odor of dairy products were identified in accordance with the following procedures.

### Preparation of Dairy Product

15 kg of high-fructose corn syrup and 0.5 kg of SM-1200(*1) were added to 79 kg of water, and stirred for 10 minutes at 80° C. to be dissolved. The resulting solution was cooled to room temperature, and 4.3 kg of non-fat dry milk was added and dissolved. Further, a liquid obtained by dissolving 0.54 kg of citric acid (anhydrous) in 0.7 kg of water was added. The resulting mixed liquid was heated to 80° C., homogenized at 14.7 MPa using a homogenizer (Izumi Food Machinery Co., Ltd.) and subjected to hot-pack filling at 93° C., thereby preparing a milk beverage.

*1: Stabilizer containing soybean polysaccharide as an active ingredient/San-Ei Gen F.F.I., Inc.

### Light-Deterioration Treatment

A light-deteriorated milk beverage was prepared by storing the milk beverage prepared above under fluorescent light irradiation (10000 lux) at 10° C. for 10 days. At the same time, separately, a milk beverage free of light deterioration was prepared by storing the milk beverage prepared above in a refrigerator under a light-shielded condition at 5° C. for 10 days.

### Identification of Major Odorant Substances Causing Light-Deterioration Odor

The milk beverage subjected to the light-deterioration treatment and the milk beverage without the light-deterioration treatment were analyzed by GC/O. Based on the difference in odorant substance due to the presence/absence of light-deterioration treatment, five substances, i.e., dimethyl disulfide, 1-octen-3-one, methional, 4,5-epoxy-trans-2-decenal, and trans-2-nonenal, were identified as major odorant substances causing light-deterioration odor.

The measurement by GC/O was performed according to the following conditions.

GC/O device: 6890N (Agilent Technologies)/CharmAnalysis™ (Datu, Inc.)
Column: DB-WAX/length=15 m, inner diameter=0.32 mm (Agilent Technologies)
Column temperature conditions: 40 to 220° C., heating rate: 6° C./min

### Carrier gas: Helium

### Verification of Major Odorant Substances Causing Light-Deterioration Odor

Dimethyl disulfide, 1-octen-3-one, methional, 4,5-epoxy-trans-2-decenal, and trans-2-nonenal, identified as major odorant substances, were added to a milk beverage that was not subjected to light-deterioration treatment, in an amount of 1 ppb, 0.25 ppb, 1 ppb, 1 ppb, and 1 ppb, thereby preparing pseudo-light-deteriorated milk beverage. The sensory evaluation of the pseudo-light-deteriorated milk beverage was performed according to the following evaluation criteria by 10 panelists, using a light-deteriorated milk beverage as a comparative sample. The evaluation average of 10 panelists was 4.2. It was thus confirmed that dairy product light-deterioration odor was well reproduced by five kinds of major odorant substances.

### Sensory Evaluation Criteria

Same odor as that of milk beverage subjected to a light-deterioration treatment was confirmed: 5 points
Similar odor to that of milk beverage subjected to a light-deterioration treatment was confirmed: 4 points
Similar odor to that of milk beverage subjected to a light-deterioration treatment and a different odor were mixed: 3 points
Different odor from that of milk beverage subjected to a light-deterioration treatment was confirmed: 2 points
Completely different odor from that of milk beverage subjected to a light-deterioration treatment was confirmed: 1 point

### Test Example 1

Masking Effects of the Compounds in Group A with Respect to Dimethyl Sulfide

Dimethyl disulfide was diluted with 95% ethanol at a concentration of 1 mass %. The diluent was added to purified water so that the concentration of dimethyl sulfide was 1 ppb. The compound in Group A (menthyl acetate, linalyl acetate, isoamyl isovalerate, or isoamyl butyrate) was added to the dimethyl disulfide-containing aqueous solution thus prepared above at the concentrations shown in FIG. 1. The masking effects of the compounds with respect to dimethyl disulfide were confirmed by sensory evaluation.

The sensory evaluation was performed based on the following evaluation criteria in which the purified water containing 1 ppb dimethyl sulfide is evaluated as “Strong dimethyl disulfide odor was confirmed: 4 points,” and purified water is evaluated as “No dimethyl disulfide odor was confirmed: 0 points.” The evaluations were performed by providing evaluation scores, based on the following evaluation criteria, from 10 skilled panelists. Table 1 shows the average of the evaluation scores.

### Evaluation Criteria

Strong dimethyl disulfide odor was confirmed: 4 points
Dimethyl disulfide odor was confirmed: 3 points
Slight dimethyl disulfide odor was confirmed: 2 points
Dimethyl disulfide odor was hardly confirmed: 1 point
No dimethyl disulfide odor was confirmed: 0 points

TABLE 1

| | Concentration | Evaluation |
|---|---|---|
| | in Addition | Score |
| Group A Compounds | (ppb) | (Average) |
| Menthyl acetate | 1 | 1.5 |
| Linalyl acetate | 1 | 1.5 |
| Isoamyl isovalerate | 1 | 1.6 |
| Isoamyl butyrate | 1 | 1.6 |

Further, the relationship between the concentration of the Group A compound and masking effects with respect to dimethyl sulfide was analyzed.

Menthyl acetate at the concentrations shown in Table 2 was added to purified water having a dimethyl disulfide concentration of 1 ppb, and the relationship between the amount of menthyl acetate and the masking effects with respect to dimethyl disulfide was evaluated by the same method as described above. Table 2 shows the results.

TABLE 2

| | Evaluation |
|---|---|
| Concentration of Menthyl | Score |
| acetate (ppb) | (Average) |
| 0.0001 | 3.4 |
| 0.001 | 2.6 |
| 0.01 | 2.4 |
| 0.1 | 2.1 |
| 1 | 1.5 |
| 10 | 2.4 |
| 100 | 2.5 |

### Test Example 2

Masking Effects of the Compounds in Group B with Respect to 1-octen-3-one

The same method as in Test Example 1 was performed, except that the compounds of Group B (nerol, acetaldehyde, methyl salicylate, or 1,8-cineole) were used instead of the compounds of Group A; 1-octen-3-one was used instead of dimethyl disulfide; and the concentration of 1-octen-3-one in the test liquid was changed to 0.25 ppb, thereby evaluating the masking effects of the compounds of Group B with respect to 1-octen-3-one, as well as the masking effects in relation to the amount of nerol. Tables 3 and 4 show the results.

TABLE 3

| | Concentration | Evaluation |
|---|---|---|
| | in Addition | Score |
| Group B Compounds | (ppb) | (Average) |
| Nerol | 0.25 | 1.6 |
| Acetaldehyde | 0.25 | 1.8 |
| Methyl salicylate | 0.25 | 1.7 |
| 1,8-cineole | 0.25 | 1.6 |

TABLE 4

| | Evaluation |
|---|---|
| | Score |
| Concentration of Nerol (ppb) | (Average) |
| 0.000025 | 3.6 |
| 0.00025 | 2.6 |
| 0.0025 | 2.4 |
| 0.025 | 2.3 |
| 0.25 | 1.6 |
| 2.5 | 2.3 |
| 25 | 2.5 |

### Test Example 3

Masking Effects of the Compounds in Group C with Respect to Methional

The same method as in Test Example 1 was performed, except that the compounds of Group C (maltol isobutyrate, ethyl pyruvate, heliotropine, or diethyl malonate) were used instead of the compounds of Group A; and methional was used instead of dimethyl disulfide, thereby evaluating the masking effects of the compounds of Group C with respect to methional, as well as the masking effects in relation to the amount of maltol isobutyrate. Tables 5 and 6 show the results.

TABLE 5

| | Concentration | Evaluation |
|---|---|---|
| | in Addition | Score |
| Group C Compounds | (ppb) | (Average) |
| Maltol isobutyrate | 1 | 1.6 |
| Ethyl pyruvate | 1 | 1.7 |
| Heliotropine | 1 | 1.6 |
| Diethyl malonate | 1 | 1.5 |

TABLE 6

| | Evaluation |
|---|---|
| Concentration of Maltol isobutyrate | Score |
| (ppb) | (Average) |
| 0.0001 | 3.6 |
| 0.001 | 2.5 |
| 0.01 | 2.4 |
| 0.1 | 2.1 |
| 1 | 1.6 |
| 10 | 2.3 |
| 100 | 2.5 |

### Test Example 4

Masking Effects of the Compounds in Group D with Respect to 4,5-epoxy-trans-2-decenal

The same method as in Test Example 1 was performed, except that the compounds of Group D (ethyl levulinate, ethyl pyruvate, γ-butyrolactone, or benzyl alcohol) were used instead of the compounds of Group A; and 4,5-epoxy-trans-2-decenal was used instead of dimethyl disulfide, thereby evaluating the masking effects of the compounds of Group D with respect to 4,5-epoxy-trans-2-decenal, as well as the masking effects in relation to the amount of ethyl levulinate. Tables 7 and 8 show the results.

TABLE 7

| | Concentration | Evaluation |
|---|---|---|
| | in Addition | Score |
| Group D Compounds | (ppb) | (Average) |
| Ethyl levulinate | 1 | 1.5 |
| Ethyl pyruvate | 1 | 1.5 |
| γ-butyrolactone | 1 | 1.7 |
| Benzyl alcohol | 1 | 1.6 |

TABLE 8

| | Evaluation |
|---|---|
| Concentration of Ethyl levulinate | Score |
| (ppb) | (Average) |
| 0.0001 | 3.5 |
| 0.001 | 2.4 |
| 0.01 | 2.1 |
| 0.1 | 2.1 |
| 1 | 1.5 |
| 10 | 2.2 |
| 100 | 2.4 |

### Test Example 5

Masking Effects of the Compounds in Group E with Respect to trans-2-nonenal

The same method as in Test Example 1 was performed, except that the compounds of Group E (hexanal, γ-hexalactone, ethyl propionate, or amyl acetate) were used instead of the compounds of Group A; and trans-2-nonenal was used instead of dimethyl disulfide, thereby evaluating the masking effects of the compounds of Group E with respect to trans-2-nonenal, as well as the masking effects in relation to the amount of hexanal. Tables 9 and 10 show the results.

TABLE 9

| | Concentration | Evaluation |
|---|---|---|
| | in Addition | Score |
| Group E Compounds | (ppb) | (Average) |
| Hexanal | 1 | 1.6 |
| γ-hexalactone | 1 | 1.6 |
| Ethyl propionate | 1 | 1.8 |
| Amyl acetate | 1 | 1.6 |

TABLE 10

| | Evaluation |
|---|---|
| | Score |
| Concentration of Hexanal (ppb) | (Average) |
| 0.0001 | 3.5 |
| 0.001 | 2.6 |
| 0.01 | 2.5 |
| 0.1 | 2.2 |
| 1 | 1.6 |
| 10 | 2.2 |
| 100 | 2.6 |

The results of Tables 1 to 10 revealed that the masking agent compounds of Groups A to E respectively serve as effective masking agents with respect to dimethyl disulfide, 1-octen-3-one, methional, 4,5-epoxy-trans-2-decenal, and trans-2-nonenal; and that the masking effects of four compounds in each group were nearly equal. It was further revealed that the masking effects of the compounds of Groups A to E tend to increase when the amount of the masking agent compound is similar to the amount of the odorant substance. Remarkably, there was a tendency for the masking effects with respect to the target odorant substance to be weakened not only when the amount of the masking agent compound was small, but also when the amount of the masking agent compound was excessively large.

### Test Example 6

Masking Effects of Deterioration-Odor Masking Agent with Respect to Pseudo-Light-Deteriorated Milk Beverage Obtained by Adding Major Odorant Substance to Milk Beverage

The masking agent compounds shown in Table 11 were added to the pseudo-light-deteriorated milk beverage prepared in the section “Verification of major odorant substances causing light deterioration-odor” above in amounts specified in the table, thereby confirming the masking effects of the masking agent compounds by sensory evaluation.

The sensory evaluation was performed based on the following evaluation criteria in which the pseudo-light-deteriorated milk beverage is evaluated as “Strong odor was confirmed: 4 points,” and a milk beverage free of a light-deterioration odor substance (i.e., milk beverage without a light-deterioration treatment) is evaluated as “No odor was confirmed: 0 points.” The evaluations were performed by providing evaluation scores from 10 skilled panelists. Table 11 shows the average of the evaluation scores.

### Evaluation Criteria

Strong odor was confirmed: 4 points
Odor was confirmed: 3 points
Slight odor was confirmed: 2 points
Odor was hardly confirmed: 1 point
No odor was confirmed: 0 points

TABLE 11

| | Amount of Masking Agent Relative to Pseudo-Light-Deteriorated Milk | | | | | | Sensory |
|---|---|---|---|---|---|---|---|
| | Beverage (ppb) | | | | | | Evaluation |
| Test | Menthyl | | | Maltol | Ethyl | | Score |
| Example | acetate | Nerol | Acetaldehyde | isobutyrate | levulinate | Hexanal | (Average) |
| 6-1 | 1 | — | — | — | — | — | 1.8 |
| 6-2 | — | 0.25 | — | — | — | — | 1.9 |
| 6-3 | — | — | 1 | — | — | — | 1.7 |
| 6-4 | — | — | — | 1 | — | — | 1.7 |
| 6-5 | — | — | — | — | 1 | — | 1.8 |
| 6-6 | — | — | — | — | — | 1 | 1.8 |
| 6-7 | 1 | 0.25 | — | — | — | — | 1.4 |
| 6-8 | 1 | — | — | 1 | — | — | 1.6 |
| 6-9 | 1 | — | — | — | 1 | — | 1.5 |
| 6-10 | — | 0.25 | — | 1 | — | — | 1.5 |
| 6-11 | — | 0.25 | — | — | 1 | — | 1.5 |
| 6-12 | — | — | — | 1 | — | 1 | 1.6 |
| 6-13 | — | — | — | — | 1 | 1 | 1.5 |
| 6-14 | 1 | 0.25 | — | 1 | — | — | 1.4 |
| 6-15 | 1 | — | — | 1 | 1 | — | 1.5 |
| 6-16 | — | 0.25 | — | — | 1 | 1 | 1.5 |
| 6-17 | 1 | 0.25 | — | 1 | 1 | 1 | 1.4 |

The results of Table 11 revealed that one compound respectively selected from Group A (menthyl acetate), Group B (nerol or acetaldehyde), Group C (maltol isobutyrate), Group D (ethyl levulinate), and Group E (hexanal) effectively masked light-deterioration odor in the pseudo-light-deteriorated milk beverage obtained by reproducing a light-deterioration state, and also effectively masked deterioration odor (Test Examples 6-1 to 6-6). Further, it was confirmed that Test Examples 6-7 to 6-13, in which two compounds were selected from different groups of Groups A to E, showed further superior light-deterioration-odor masking effects, compared with the case using only one compound. Additionally, even more superior light-deterioration-odor masking effects were confirmed in Test Examples 6-14 to 6-16, in which three kinds of compounds were individually selected from different groups of Groups A to E, and Test Example 6-17, in which five kinds of compounds were individually selected from different groups of Groups A to E; and further superior deterioration-odor masking effects were also exhibited.

### Example 1

### Masking Effects of Deterioration-Odor Masking Agent in Milk Beverage

The masking agent compounds shown in Table 12 were added to the milk beverage prepared in the section “Preparation of Dairy Product” above in amounts specified in the table, and the entire amounts of the resulting milk beverages were placed in transparent PET bottles having a capacity of 220 ml. Each bottle was closed airtight with a stopper.

The masking agent-added milk beverages thus prepared were stored at 10° C. for 10 days under irradiation of fluorescent light (10000 lux), together with a milk beverage in which the masking agent compound was not added. At the same time, separately, a milk beverage in which the masking agent compound was not added was stored in a refrigerator at 5° C. for 10 days under a light-shielded condition, thereby preparing a milk beverage free of light deterioration.

With regard to the milk beverages in which a masking agent was not added, the following evaluation criteria were set in which the milk beverage subjected to fluorescent light irradiation is evaluated as “Strong odor was confirmed: 4 points,” and the milk beverage stored under a light-shielded condition is evaluated as “No odor was confirmed at all: 0 points.” Based on these criteria, the deterioration-odor masking effects of milk beverages in which a masking agent was added were evaluated. The evaluation was performed by 10 skilled panelists. Table 12 shows the average of the evaluation scores.

### Evaluation Criteria

Strong odor was confirmed: 4 points
Odor was confirmed: 3 points
Slight odor was confirmed: 2 points
Odor was hardly confirmed: 1 point
No odor was confirmed: 0 points

TABLE 12

| | Amount of Masking | | | |
|---|---|---|---|---|
| | Agent Relative to Milk | | | Sensory |
| | Beverage (ppb) | | | Evaluation |
| | Menthyl | | | Score |
| | acetate | Nerol | Maltol isobutyrate | (Average) |
| Example 1-1 | 1 | — | — | 1.8 |
| Example 1-2 | — | 0.25 | — | 1.7 |
| Example 1-3 | — | — | 1 | 1.9 |
| Example 1-4 | 1 | 0.25 | 1 | 1.4 |

The results of Table 12 revealed that menthyl acetate (Group A), nerol (Group B), and maltol isobutyrate (Group C) each effectively masked light-deterioration odor generated by light irradiation in a milk beverage, and also effectively masked deterioration odor. The results also revealed that further superior masking effects were exhibited when the three substances menthyl acetate, nerol, and maltol isobutyrate were added.

### Example 2

### Masking Effects of Deterioration-Odor Masking Agent in Ice Cream

According to the formulation shown in Table 13, ice cream was prepared as follows. A powder mixture of non-fat dry milk, sugar, SAN BEST®NN-305, and HOMOGEN® DM-S was added to water, cream, sweetened condensed milk, and starch syrup under stirring with a propeller stirring blade; and heating was started. After the liquid temperature reached 80° C., butter was added, and the mixture was stirred at 80° C. for 10 minutes. Thereafter, the prepared solution was treated at 14.7 MPa using a homogenizer (Izumi Food Machinery Co., Ltd.). The treated liquid was aged at 5° C. or less; and, after freezing (OR: 25%), placed in an ice mold, hardened in a brine tank, and then placed in a transparent zippered polyethylene bag (2.4 cm×1.7 cm) in an amount of about 100 g. As the masking agent, the compounds shown in Table 14 were added in amounts specified in the table upon the aging at 5° C. or less.

The masking agent-added ice cream thus prepared was stored at −20° C. for 3 days under irradiation of fluorescent light (6000 lux), together with ice cream in which the masking agent compound was not added. At the same time, separately, ice cream in which the masking agent compound was not added was stored in a freezer at −20° C. under a light-shielded condition.

With regard to the ice cream in which a masking agent was not added, the following evaluation criteria were set in which the ice cream subjected to fluorescent light irradiation is evaluated as “Strong odor was confirmed: 4 points,” and the ice cream stored under a light-shielded condition is evaluated as “No odor was confirmed: 0 points”; and the deterioration-odor masking effects of ice cream in which a masking agent was added were evaluated. The evaluation was performed by 10 skilled panelists. Table 14 shows the average of the evaluation scores.

### Evaluation Criteria

Strong odor was confirmed: 4 points
Odor was confirmed: 3 points
Slight odor was confirmed: 2 points
Odor was hardly confirmed: 1 point
No odor was confirmed: 0 points

TABLE 13

| | Formulation |
|---|---|
| Materials | (%) |
| Cream (Milkfat = 45%) | 10 |
| Sweetened condensed milk | 10 |
| Butter (salt-free) | 8.5 |
| Non-fat dry milk | 5 |
| Starch syrup | 10 |
| Sugar | 5 |
| SAN BEST (R) NN-305 (*1) | 0.1 |
| HOMOGEN (R) DM-S (*2) | 0.3 |
| Total of mixture following | 100 |
| the addition of water | |

(*1): Stabilizer containing a polysaccharide thickener as an active ingredient/San-Ei Gen F.F.I., Inc.
(*2): Emulsifier containing glycerin fatty acid ester as an active ingredient/San-Ei Gen F.F.I., Inc.

TABLE 14

| | | | | Sensory |
|---|---|---|---|---|
| | Amount of Masking Agent Relative | | | Evaluation |
| | to Ice Cream (ppb) | | | Score |
| | Nerol | Ethyl levulinate | Hexanal | (Average) |
| Example 2-1 | 1 | — | — | 1.9 |
| Example 2-2 | — | 1 | — | 1.8 |
| Example 2-3 | — | — | 1 | 1.8 |
| Example 2-4 | 1 | 1 | 1 | 1.5 |

The results of Table 14 revealed that nerol (Group B), ethyl levulinate (Group D), and hexanal (Group E) each solely effectively masked light-deterioration odor generated by light irradiation in ice cream, and also effectively masked deterioration odor. The results also revealed that further superior masking effects were exhibited when the three substances nerol, ethyl levulinate, and hexanal were added.

1. A dairy product deterioration-odor masking agent, comprising one compound, or two or more compounds selected from the group consisting of the following Groups A to E,
Group A: menthyl acetate, linalyl acetate, isoamyl isovalerate, and isoamyl butyrate;
Group B: nerol, acetaldehyde, methyl salicylate, and 1,8-cineole;
Group C: maltol isobutyrate, ethyl pyruvate, heliotropine, and diethyl malonate;
Group D: ethyl pyruvate, γ-butyrolactone, ethyl levulinate, and benzyl alcohol; and
Group E: hexanal, γ-hexalactone, ethyl propionate, and amyl acetate.

2. The dairy product deterioration-odor masking agent according to claim 1, wherein the dairy product deterioration-odor masking agent comprises two or more compounds selected from the group consisting of Groups A to E, and at least two compounds among the selected compounds are from different groups of Groups A to E.

3. The dairy product deterioration-odor masking agent according to claim 1, wherein the dairy product deterioration-odor masking agent comprises three or more compounds selected from the group consisting of Groups A to E, and at least three compounds of the selected compounds are from different groups of Groups A to E.

4. A method for masking a deterioration odor of a dairy product, comprising adding the deterioration-odor masking agent according to claim 1 to a dairy product.

5. A method for producing a dairy product, comprising adding the deterioration-odor masking agent according to claim 1 to a dairy product.

6. A dairy product comprising the deterioration-odor masking agent according to claim 1.
